(19) United States
(12) Patent Application Publication
(10) Pub. No.: US 2026/0279924 A1
(43) Pub. Date: Sep. 17, 2026

(54) SCISSOR FIXTURE FOR BATTERY ASSEMBLY AND RELATED METHOD

(71) Applicant: Gridtential Energy, Inc., Santa Clara, CA (US)

(72) Inventor: Nicholas G. Bauer, San Francisco, CA (US)

(21) Appl. No.: 19/564,876

(22) Filed: Mar. 12, 2026

Related U.S. Application Data
(60) Provisional application No. 63/770,519, filed on Mar. 12, 2025.

(51) Int. Cl. H01M 10/12

(52) U.S. Cl. CPC H01M 10/127; H01M 10/128

(57) ABSTRACT

Fabrication of a battery assembly, such as a bipolar battery assembly, can include placing a stack of modules or bipolar plate (e.g., “biplate”) elements in compression and keeping such a stack captive in compression during or after a welding operation. To facilitate such stacking and compression, the present inventor has, among other things, developed a fixture comprising tray structures that can hold (e.g., support) respective casing portions of the bipolar battery assembly. The tray structures can move away from or toward each other, such as having motion constrained by an articulating structure between respective trays. For example, as shown and described herein one or more scissor structures can be included to couple respective trays to each other.

### CLAIM OF PRIORITY

This patent application claims the benefit of priority of Nicholas G. Bauer U.S. Provisional Patent Application No. 63/770,519, titled “SCISSOR FIXTURE FOR BATTERY ASSEMBLY AND RELATED METHOD,” filed on Mar. 12, 2025 (Attorney Docket No. 3601.034PRV), which is hereby incorporated by reference herein in its entirety.

### FIELD OF THE DISCLOSURE

This document pertains generally, but not by way of limitation, to apparatus and techniques for performing battery assembly, and more particularly to fixturing, assembly techniques, and casing configurations that can be used to facilitate fabrication of a bipolar battery assembly.

### BACKGROUND

The lead acid battery can be considered the earliest type of rechargeable battery, and lead acid chemistry remains the most used battery chemistry. The active materials in a lead acid battery generally include lead dioxide (PbO₂), lead (Pb), and sulfuric acid (H₂SO₄) which also acts as the electrolyte. To assemble a lead acid battery having a monopolar architecture, PbO₂ and Pb active materials can be pasted and cured onto monopolar lead current collectors to provide positive and negative plates, from which an electrochemical cell can be formed with H₂SO₄ electrolyte. Manufacturing of a monopolar lead acid battery may include a few basic operations. The base material for current collector grids may include lead along with elements other than lead metal alone, such as to provide an alloy to improve mechanical properties without affecting electrochemical characteristics. However, alloying elements or compounds may promote side reactions during battery operation. As side reactions compete with the electrochemical reactions of charging and discharge, battery performance can be degraded. After the grids are formed, one of a positive or negative active material is applied (e.g., “pasted”) onto respective grids to provide monopolar battery “plates,” and the plates are then cured. The pasted and cured positive and negative plates can be stacked alternately with separators to form “plate-blocks.” A multi-cell battery may be constructed by connecting multiple plate blocks electrically.

### SUMMARY OF THE DISCLOSURE

A bipolar battery architecture offers improvements over a monopolar battery configuration. In a bipolar configuration, because cells are arranged electrically in series to multiply the cell voltage, current flows in a direction generally perpendicular to the surface of the plates. Fabrication of a bipolar battery involves forming a bipolar current collector to provide a substrate material (such as a conductive substrate). Positive and negative active materials are applied to at least a portion of opposite surfaces of the bipolar current collector to provide a bipolar plate or “biplate.” Generally, multiple bipolar plates are compressed and stacked alternately with separators to establish individual cell compartments, which are to be isolated from each other. Respective cell compartments are populated with electrolyte (e.g., a liquid or gel electrolyte), and the battery stack can undergo a process (e.g., “forming” or “formation”), to activate the cathode and anode materials. In the bipolar configuration, a conductive substrate of the current collector can provide an inter-cell electrical connection, with the anode of one cell conductively coupled to the cathode of the next cell on the opposite side of the bipolar current collector via conduction through the substrate.

The present inventor has recognized, among other things, that fabricating a battery assembly, such as a bipolar battery assembly, can include placing a stack of modules or bipolar plate (e.g., “biplate”) elements in compression and keeping such a stack captive in compression during or after a welding operation. To facilitate such stacking and compression, the present inventor has, among other things, developed a fixture comprising tray structures that can hold (e.g., support) respective casing portions of the bipolar battery assembly. The tray structures can move away from or toward each other, such as having motion constrained by an articulating structure between respective trays. For example, as shown and described herein one or more scissor structures can be included to mechanically tie respective trays to each other. In this manner, as a separation is established (e.g., increased or decreased, or maintained) between one tray structure and another, the same separation can be maintained between other tray structures (e.g., equidistance). Such an approach can provide uniform compression of battery elements during fabrication.

In an example, an outer compression fixture can include respective trays configured to house casing portions of a battery assembly for compression within the outer compression fixture. For example, as a separation is established between one tray and another, a same separation is maintained between other trays of the respective trays. The trays can be coupled together using at least one scissor structure, as an illustration.

In an example, a method can be used for aligning and compressing casing portions of a bipolar battery assembly, the method comprising inserting battery casing portions into respective trays of a fixture, the fixture comprising at least one scissor structure coupling the respective trays, and compressing the casing portions together using the fixture, the at least one scissor structure facilitating uniform compression of the casing portions. For example, one or more panels can be affixed to the battery assembly, the one or more panels maintaining compression of the battery assembly after fixturing is removed. Affixing the panels can include using a welding or bonding operation, without requiring a welding or bonding operation to be performed at each joint between adjacent casing frame portions.

This summary is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

FIG. 1A illustrates generally an example that can include a monopolar battery architecture.

FIG. 1B illustrates generally an example showing a battery assembly having a bipolar architecture.

FIG. 2A illustrates generally an example comprising a fixture that can be used to compress a stack of casing portions in relation to fabrication of a bipolar battery assembly.

FIG. 2B illustrates generally an example comprising a tray that can be included as a portion of the fixture shown in FIG. 2A.

FIG. 3A illustrates generally an example comprising bipolar battery casing portions occupying respective trays in the fixture of FIG. 2A, in an uncompressed configuration.

FIG. 3B illustrates generally an example comprising bipolar battery casing portions occupying respective trays in the fixture of FIG. 2A, in a compressed configuration.

FIG. 4A illustrates generally an example of a bipolar battery assembly captive within a compression fixture that has been removed from the assembly fixture of FIG. 3B.

FIG. 4B illustrates generally another example of the bipolar battery assembly captive within the compression fixture of FIG. 4A.

FIG. 5 illustrates generally a side view of the fixture of FIG. 2A, showing a scissor structure that can be used to mechanically couple respective trays together.

FIG. 6 illustrates generally a portion of the scissor structure of FIG. 5, including links between respective trays.

FIG. 7A illustrates generally a first stage of a technique for aligning and compressing casing portions of a bipolar battery assembly using the fixture of FIG. 2A, with the fixture configured to allow insertion of battery casing portions.

FIG. 7B illustrates generally a second stage of the technique of FIG. 7A, with the fixture populated with battery casing portions and portions of an inner compression fixture inserted in the fixture.

FIG. 7C illustrates generally a third stage of the technique of FIG. 7A, with the casing portions compressed together.

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

### DETAILED DESCRIPTION

The present subject matter can include or use a fixture comprising tray structures that can hold (e.g., support) respective casing portions of battery assembly. The tray structures can move away from or toward each other, such as having motion constrained by an articulating structure between respective trays. For example, as shown and described herein one or more scissor structures can be included to mechanically tie respective trays to each other. In this manner, as a separation is established (e.g., increased or decreased, or maintained) between one tray structure and another, the same separation is maintained between other tray structures. Such an approach can provide uniform compression of battery elements during fabrication. For example, the fixture as shown and described herein can include a pressure plate that engages one or more other portions of the fixture. As the pressure plate is moved, a scissor structure can be actuated to move the respective trays apart from each other or toward each other. The trays can include features such as stops, tabs, channels, or ledges to engage respective casing portions (e.g., casing trays) housing respective bipolar plates. As an illustrative example, respective battery casing portions can be modular, such as including a bipolar battery plate supporting positive and negative active materials (PAM and NAM) on opposite sides, along with gasketing, seals, or separators. The casing portions can include alignment features such as pins or posts and corresponding cavities to facilitate alignment as the casing portions are uniformly compressed against each other.

An operation can be performed to fuse respective casing portions to each other, such as using adhesive, laser welding, or vibration (e.g., acoustic) welding techniques. As an illustrative example, a side plate can be welded to end casing segments on opposite ends of the bipolar battery assembly, to hold the bipolar battery assembly in compression after outer fixturing is removed without requiring welds between each respective casing portion. The present subject matter can include an outer or assembly fixture comprising the scissor structure to initially compress the bipolar battery assembly, along with an inner compression fixture that is more compact and can hold the bipolar battery assembly in compression after removal from the outer assembly fixture. The inner compression fixture can include posts that are arranged to avoid interference with mechanical portions of the tray assembly, such as the slides during removal from the outer assembly fixture.

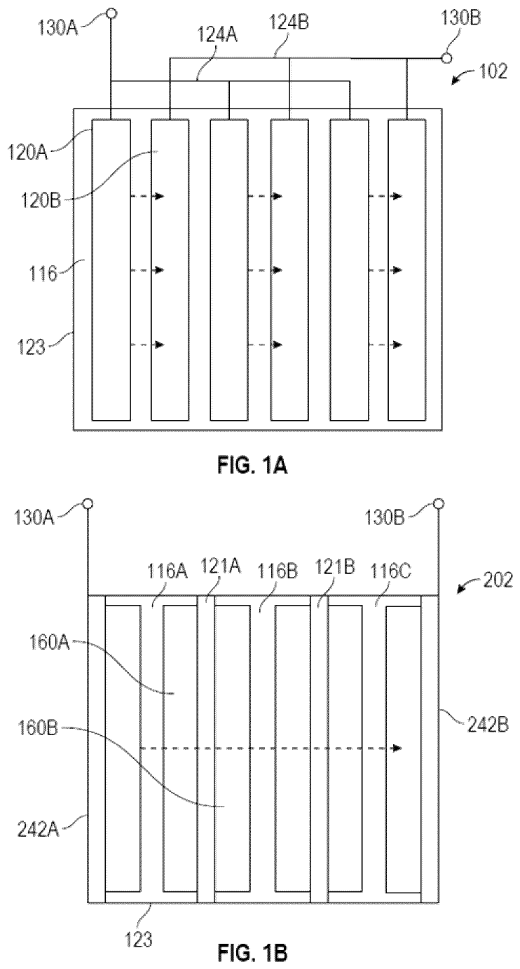

FIG. 1A illustrates generally an example that can include a monopolar battery architecture. In a monopolar configuration, a current collector generally includes an active material of a single polarity (e.g., positive or negative) applied to both (e.g., opposite) sides of the current collector, such as including application of the active material in paste form. A positive-negative pair can be formed such as including the first plate 120A having a first polarity active material and a second plate 120B having an opposite second polarity active material, to form an electrochemical cell when surrounded in an electrolyte in region 116, such as shown illustratively in FIG. 1A. In a lead-acid example, such a single-cell voltage can be around 2.1V. Multiple cells can be arranged electrically as a stack (e.g., a plate block). Individual stacks can be connected in series to provide a battery assembly 102. In FIG. 1A, a first terminal 130A connected to a first bus 124A can provide a first polarity, and a second terminal 130B connected to a second bus 124B can provide an opposite second polarity.

FIG. 1B illustrates generally an example showing a battery assembly 202 having a bipolar architecture. In the bipolar configuration, because cells are arranged electrically in series to multiply the cell voltage, current flows in a direction generally perpendicular to the surface of the current collector plates. Generally, fabrication of a bipolar battery involves forming a current collector comprising a substrate material (e.g., a conductive substrate) where positive and negative active materials are applied to at least a portion of opposite surfaces of the current collector to provide a bipolar plate or “biplate.” Generally, multiple bipolar plates are compressed and stacked alternately with separators to establish individual cell compartments, which are to be isolated from each other. Each cell compartment is populated with electrolyte (e.g., a liquid or gel electrolyte), and the battery stack can be formed to activate the cathode and anode materials. In the bipolar configuration, the current collector itself (e.g., the conductive substrate) provides inter-cell electrical connection, with the anode of one cell conductively coupled to the cathode of the next cell on the opposite side of the bipolar current collector via the current collector substrate.

Referring to FIG. 1B, a bipolar architecture can provide a simpler configuration as compared to a monopolar architecture. Respective positive and negative active materials (e.g., active materials represented by regions 160A and 160B) can be applied, such as through pasting, onto opposite sides of a current collector (e.g., plate 121A) to form a bipolar plate. As in FIG. 1A, a first terminal 130A can provide a first polarity, and a second terminal 130B can provide an opposite second polarity. Such terminals 130A and 130B can be connected to end segments 242A and 242B, respectively, that can also provide electrodes leading to the first terminal 130A and second terminal 130B, respectively. The bipolar plates 121A, 121B can be arranged in a stacked configuration with electrolyte in regions 116A, 116B, and 116C for example, to form sealed cells within a casing 123. In an example, an electrolyte in region 116A can be one or more of fluidically isolated or hermetically sealed so that electrolyte cannot bypass the bipolar plate 121A to an adjacent region such as the electrolyte region 116B, or to suppress or inhibit leakage of electrolyte from the assembly 202. As shown illustratively in FIG. 1B, cells can be arranged in a series configuration forming a stack to achieve a specified terminal 130A, 130B voltage, without requiring internal bus structures. As an illustrative example, each bipolar plate can be mechanically attached to a casing portion (e.g., a modular casing frame), such as supporting a bipolar plate and having a modular (e.g., stackable) configuration.

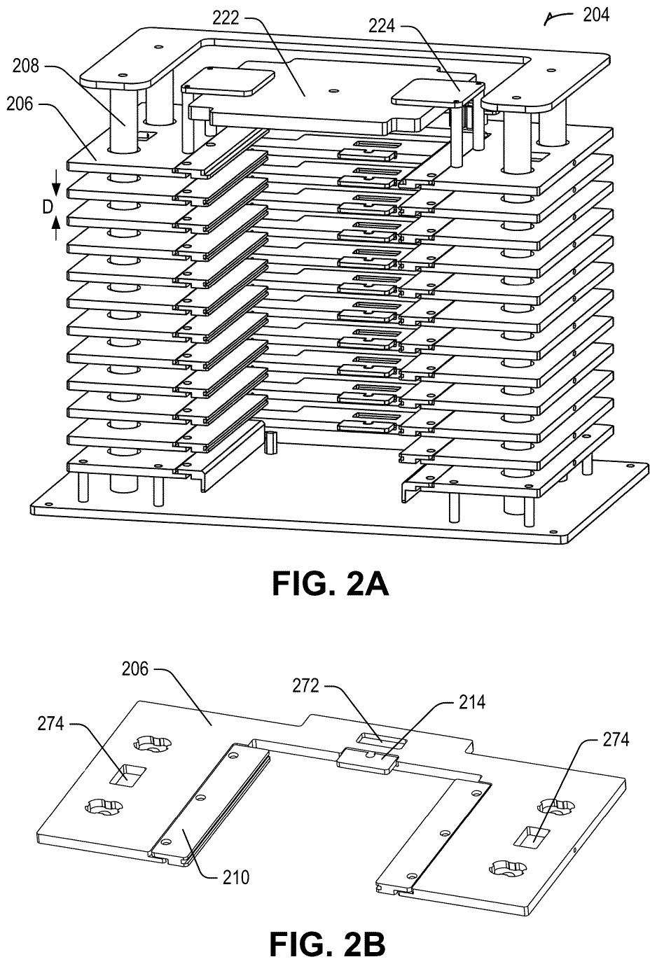

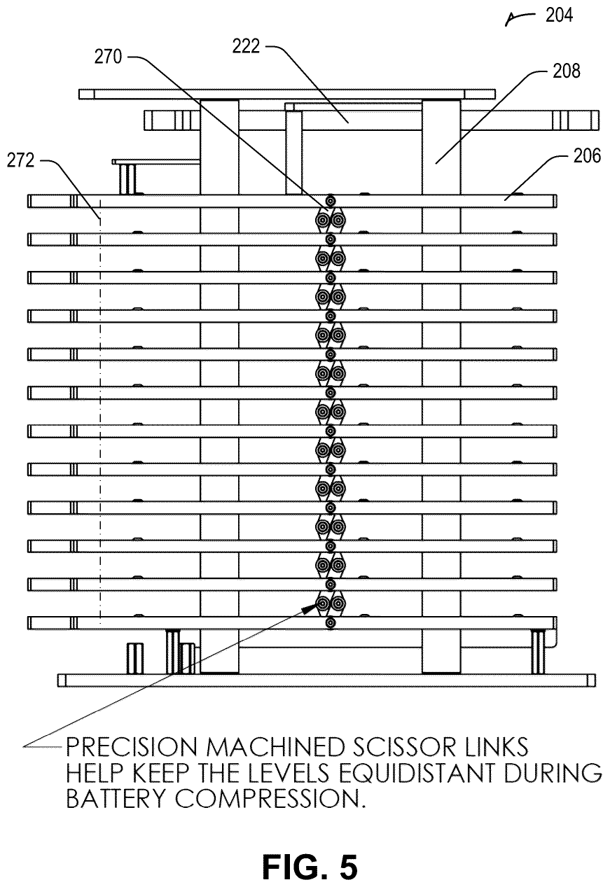

FIG. 2A illustrates generally an example comprising a fixture 204 that can be used to compress a stack of casing portions in relation to fabrication of a bipolar battery assembly. The fixture 204 can be actuated by a pressure plate 222, such as driven by a hydraulic or electrically-operated press. For example, the pressure plate 222 can be raised or lowered, with one or more tabs 224 located on the fixture 204 to allow the pressure plate 222 to lift the stack of trays (e.g., a tray 206). The trays can be guided and constrained by rails or posts, such as post 208. Motion of trays can be coupled using an articulated structure such as one or more scissor structures as shown in FIG. 5 and elsewhere herein. In this manner, motion between adjacent trays can be made more uniform throughout the stack, such as to maintain a similar distance, D, between adjacent trays as the trays are moved toward each other during a compression operation or driven apart.

FIG. 2B illustrates generally an example comprising a tray 206 that can be included as a portion of the fixture 204 shown in FIG. 2A. As mentioned above, respective casing portions (e.g., bipolar plate assemblies housed by casing frame elements) can be supported by respective trays. For example, the tray 206 can include slides (e.g., a slide 210) having shoulders or channels, or other features configured to engage with corresponding features on a modular casing frame forming a portion of a biplate assembly. The tray 206 can include a stop 214, such that when respective modular casing frame portions are inserted, they are aligned vertically and laterally when inserted far enough to engage the stop. As discussed elsewhere herein, a scissor structure can engage the tray 206, such as respective scissor structures that include pins anchored to the tray 206 in the regions 274 and 272. The tray 206 can comprise a metallic or polymer material. For example, the tray 206 can be aluminum, and other structure such as the slide 210 can be metallic (e.g., aluminum or stainless steel, or another metal or alloy) or a polymer material (e.g., polyoxymethylene, polyetherimide, polyetheretherketone, or another material).

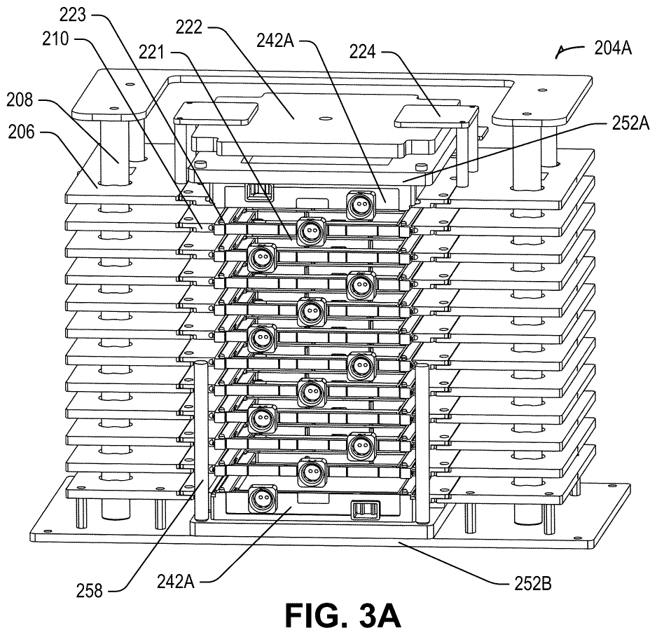

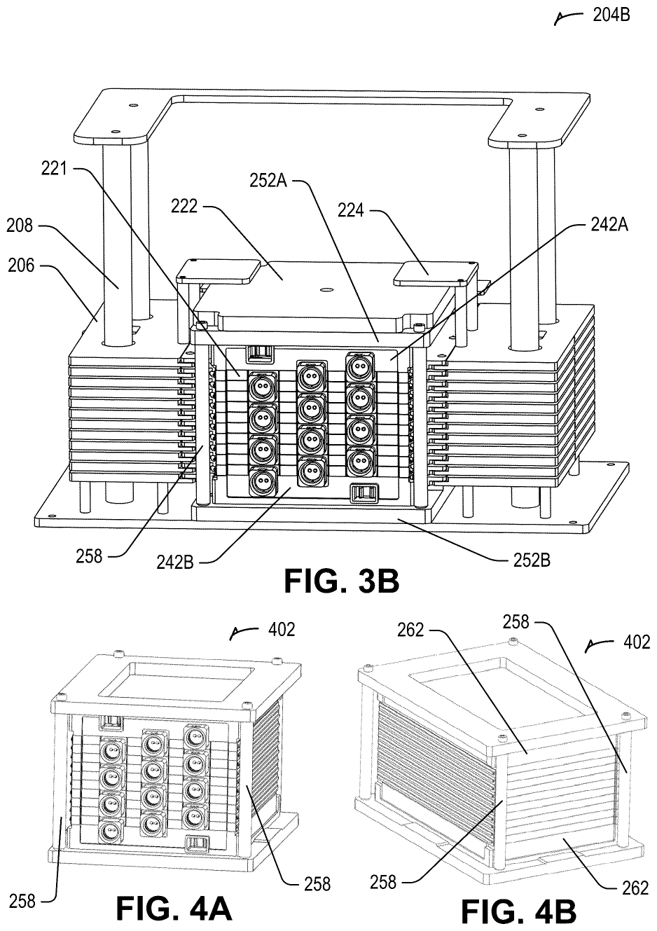

FIG. 3A illustrates generally an example comprising bipolar battery casing portions occupying respective trays in the fixture 204 of FIG. 2A, in an uncompressed configuration 204A. Referring to FIG. 3A and FIG. 3B, respective trays such as a tray 206 can support respective casing portions such as casing frame 221 supported by a slide 210. The casing frame structures need not all be identical, such as differing to accommodate different vent locations in the bipolar battery assembly, or to provide end segments 242A and 242B of the bipolar battery assembly. To insert the casing frame structures, the fixture in the uncompressed configuration 204A can be opened by the pressure plate 222 applying upward pressure to one or more tabs 224. As shown and described elsewhere herein, a compression fixture can be applied to the bipolar battery assembly to facilitate downstream processing during fabrication. For example, the compression fixture can include posts such as a post 258 and plates 252A and 252B. At least one of the plates 252A and 252B can be disconnected from the posts to allow insertion of the components of the compression fixture when the fixture 204 is in the uncompressed configuration 204A. The pressure plate 222 can be used to apply pressure to the stack of casing portions, and the casing portions can be mated to each other, such as assisted with tooling or alignment features such as a pin 223 and corresponding cavity on an adjacent casing portion. Motion of the trays in the fixture 204 can be coupled using a scissor structure as shown and described elsewhere herein, such that as compression occurs, respective trays move toward each other uniformly (e.g., maintaining corresponding distance from tray-to-tray and a similar rate of movement and compression as force is applied to the stack by the pressure plate 222).

FIG. 3B illustrates generally an example comprising bipolar battery casing portions occupying respective trays in the fixture 204 of FIG. 2A, in a compressed configuration 204B. The plates 252A and 252B can be fixed using cap screws or other fasteners. To facilitate removal of the compression fixture comprising posts (e.g., post 258) and plates 252A and 252B, the pressure plate 222 can be withdrawn slightly opening the fixture 204 using one or more tabs 224. A bipolar battery assembly and compression fixture can then be removed as a unit, to provide the assembly 402 as shown in FIG. 4A and FIG. 4B.

FIG. 4A and FIG. 4B illustrate generally examples of a bipolar battery assembly 402 captive within a compression fixture that has been removed from the assembly fixture of FIG. 3B. The post locations on the compression fixture can be offset, such as where posts 258 as shown in FIG. 4B are displaced inward to avoid interference with the fixture 204 of FIG. 2A when the assembly is removed from the fixture 204 (e.g., slid out). Once the stack is assembled and compressed, such as using fixturing as shown and described herein, one or more panels can be affixed to the battery assembly 402. Such panels can assist in maintaining compression of the battery assembly 402 after fixturing is removed, such as for a remainder of the life of the battery. For example, vibrational or laser welding, or other bonding can be performed, such as affixing a plate to the battery assembly 402 using regions 262, without requiring a welding operation to be performed at each joint between adjacent casing frame portions.

FIG. 5 illustrates generally a side view of the fixture 204 of FIG. 2A, showing a scissor structure 270 that can be used to mechanically couple respective trays together, including establishing more uniform motion of respective trays with respect to each other as they are moved apart or toward each other. As mentioned elsewhere, a pressure plate 222 can apply pressure to at least one tray 206, and the scissor structure can couple the displacement of the tray 206 uniformly to other trays in the fixture 204, as the trays travel along rails or posts such as a post 208 as shown in FIG. 5. Multiple scissor structures can be included, such as in the region 272 and on the opposite side of the fixture from the side shown in FIG. 5 (e.g., three separate scissor structures).

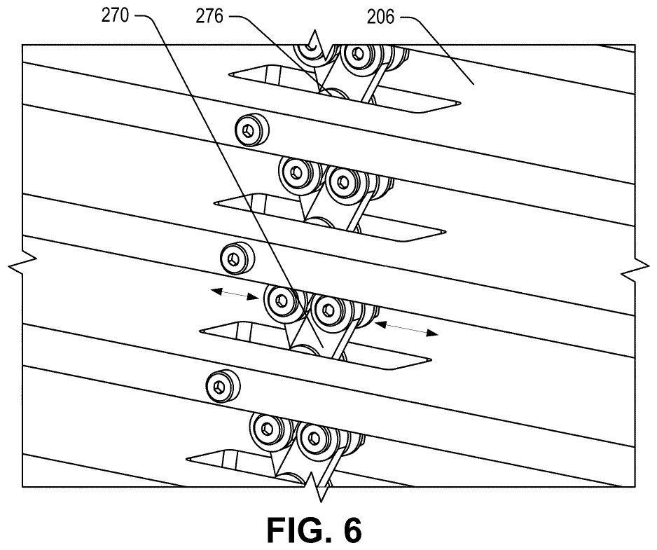

FIG. 6 shows a more detailed view of a portion of the scissor structure of FIG. 5, including links between respective trays. For example, as shown in FIG. 6, the scissor structure 270 can include segments that are configured to move (e.g., rotate and translate) in coordination with each other, such as coupled to respective trays (e.g., a tray 206) using a pin 276 or other similar structure. As the trays are moved together, the vertices of the scissor where segments are coupled together between the trays move apart from each other and vice versa (as indicated by arrows in FIG. 6)

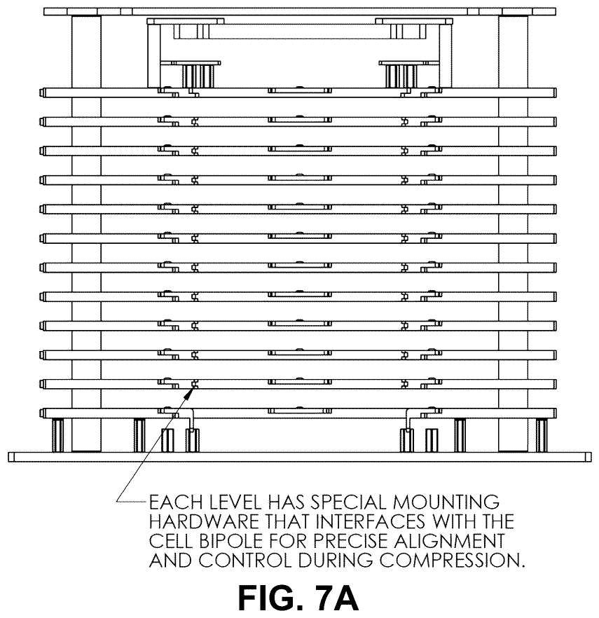

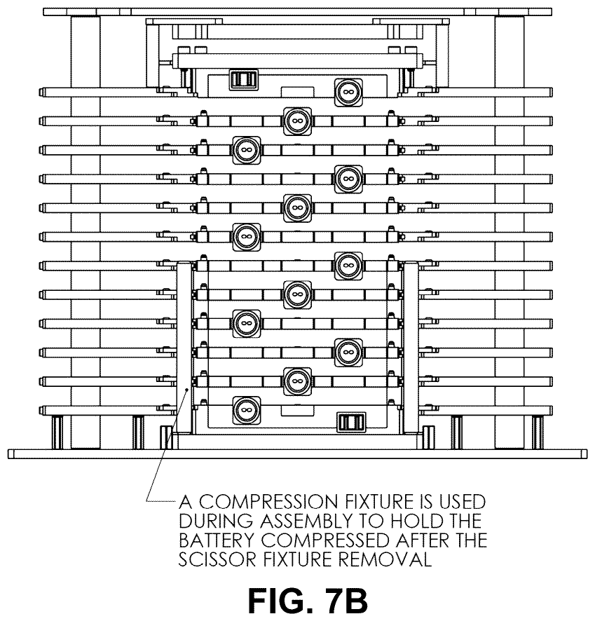

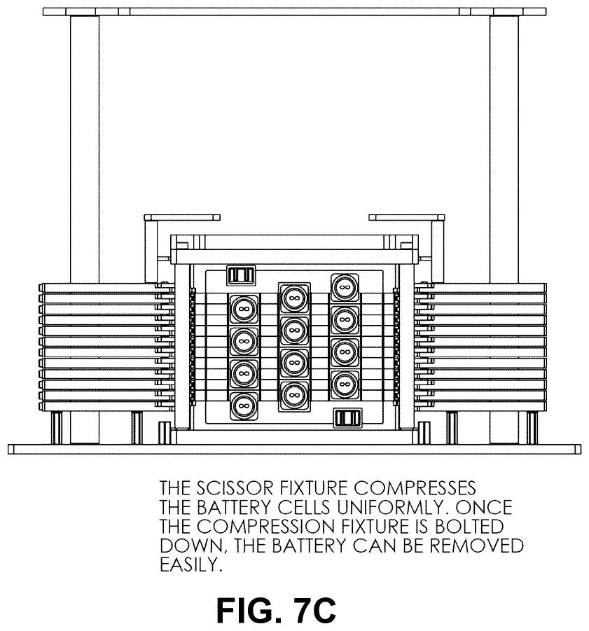

FIG. 7A, FIG. 7B, and FIG. 7C illustrate a technique, such as an assembly method, for aligning and compressing casing portions of a bipolar battery assembly using the fixture of FIG. 2A. At FIG. 7A, the fixture can be opened to allow insertion of battery casing portions, with the fixture populated with such casing portions as shown in FIG. 7B. In FIG. 7B, portions of an inner compression fixture have also been inserted in the outer fixture. At FIG. 7C, the casing portions have been compressed together, with uniform compression that can be facilitated using a scissor structure as shown and described elsewhere herein, and the compressed battery assembly (optionally including a compression fixture such as bolted together) can be removed from the outer fixture to provide a compressed assembly captive in the inner compression fixture as shown in FIG. 4A and FIG. 4B, for further processing.

### Various Notes and Examples

Example 1 can include or use subject matter such as an outer compression fixture comprising at least one scissor structure coupling respective trays, the respective trays configured to house casing portions of a battery assembly for compression within the outer compression fixture.

Example 2 can include, or can optionally be combined with the subject matter of Example 1, to optionally include a pressure plate configured to engage the outer compression fixture, wherein as the pressure plate is moved, the at least one scissor structure is actuated to move the respective trays apart from each other or toward each other.

Example 3 can include, or can optionally be combined with the subject matter of Example 2, to optionally include one or more tabs located on the outer compression fixture to allow the pressure plate to engage a stack of the respective trays.

Example 4 can include, or can optionally be combined with the subject matter of Example 2 or Example 3, to optionally include the pressure plate being driven by a press.

Example 5 can include, or can optionally be combined with the subject matter of one or any combination of Examples 1 through 4, to optionally include the respective trays including at least one feature comprising a stop, a tab, a channel, or a ledge, or combinations thereof to engage respective casing portions housing respective battery plates.

Example 6 can include, or can optionally be combined with the subject matter of one or any combination of Examples 1 through 5, to optionally include the respective trays comprising at least one slide having shoulders or channels configured to engage with corresponding features on a modular casing frame forming a portion of a battery plate assembly.

Example 7 can include, or can optionally be combined with the subject matter of Example 6, to optionally include the respective trays further comprising a stop, such that when respective modular casing frame portions are inserted, the modular casing frame portions are aligned vertically and laterally when inserted far enough to engage the stop.

Example 8 can include, or can optionally be combined with the subject matter of one or any combination of Examples 1 through 7, to optionally include the respective trays being guided and constrained by rails or posts.

Example 9 can include, or can optionally be combined with the subject matter of one or any combination of Examples 1 through 8, to optionally include that as a separation is established between one tray and another, a same separation is maintained between other trays of the respective trays.

Example 10 can include, or can optionally be combined with the subject matter of one or any combination of Examples 1 through 9, to optionally include the at least one scissor structure comprising segments that are configured to rotate and translate in coordination with each other, the segments coupled to respective trays using a pin.

Example 11 can include, or can optionally be combined with the subject matter of Example 10, to optionally include that as the respective trays are moved together, vertices of the at least one scissor structure where segments are coupled together between the trays move apart from each other.

Example 12 can include, or can optionally be combined with the subject matter of one or any combination of Examples 1 through 11, to optionally include the respective trays comprising a metallic or polymer material.

Example 13 can include, or can optionally be combined with the subject matter of one or any combination of Examples 1 through 12, to optionally include an inner compression fixture configured to hold the battery assembly in compression after removal from the outer compression fixture.

Example 14 can include, or can optionally be combined with the subject matter of Example 13, to optionally include the inner compression fixture comprising posts and plates, and the posts being arranged to avoid interference with mechanical portions of a tray assembly during removal from the outer compression fixture.

Example 15 can include, or can optionally be combined with the subject matter of one or any combination of Examples 1 through 14, to include subject matter such as a method for aligning and compressing casing portions of a bipolar battery assembly, the method comprising: inserting battery casing portions into respective trays of a fixture, the fixture comprising at least one scissor structure coupling the respective trays; and compressing the casing portions together using the fixture, the at least one scissor structure facilitating uniform compression of the casing portions.

Example 16 can include, or can optionally be combined with the subject matter of Example 15, to optionally include that compressing comprises applying pressure using a pressure plate, and that the at least one scissor structure couples displacement of a tray uniformly to other trays in the fixture.

Example 17 can include, or can optionally be combined with the subject matter of one or any combination of Examples 15 through 16, to optionally include inserting portions of an inner compression fixture into the fixture prior to compressing.

Example 18 can include, or can optionally be combined with the subject matter of Example 17, to optionally include removing the compressed battery assembly captive in the inner compression fixture from the fixture.

Example 19 can include, or can optionally be combined with the subject matter of Example 18, to optionally include affixing one or more panels to the battery assembly after removal from the fixture, the one or more panels assisting in maintaining compression of the battery assembly after fixturing is removed.

Example 20 can include, or can optionally be combined with the subject matter of Example 19, to optionally include that affixing the one or more panels comprises performing vibrational or laser welding, or other bonding, without requiring a welding operation to be performed at each joint between adjacent casing frame portions.

Example 21 can include, or can optionally be combined with any portion or combination of any portions of any one or more of Examples 1 through 20 to include subject matter that can include means for performing any one or more of the functions of Examples 1 through 20.

Each of the non-limiting aspects above can stand on its own or can be combined in various permutations or combinations with one or more of the other aspects or other subject matter described in this document.

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc., are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A method for fabricating a battery assembly, the method comprising:
assembling a stack of biplate assemblies including aligning the biplate assemblies using a fixture, the fixture having at least one feature sized and shaped to engage a corresponding feature in a first casing portion in the stack of biplate assemblies;
compressing the stack of biplate assemblies;
mating a second casing portion comprising an optically-transmissive region to the first casing portion;
irradiating an optically-absorbing region of the first casing portion through an optically-transmissive portion of the second casing portion to form a weld structure along at least one edge of the second casing portion.

2. The method of claim 1, wherein the irradiating comprises using a laser to thermally form the weld structure.

3. The method of claim 1, comprising securing the compressed stack of biplate assemblies by end structures applied to the compressed stack of biplate assemblies.

4. The method of claim 3, wherein the end structures are fastened to the fixture.

5. The method of claim 4, wherein the end structures, the fixture, and the compressed stack form a unitized assembly.

6. The method of claim 5, wherein the second casing portion comprises a panel affixed by the weld structure to the stack of biplate assemblies; and
wherein the panel, at least in part, maintains the stack of biplate assemblies in compression after removing the end structures and the fixture.

7. The method of claim 6, wherein the panel affixed by the weld structure to the stack of biplate assemblies is amongst four panels each located on different sides of the stack of biplate assemblies, the four panels maintaining the stack of biplate assemblies in compression after removing the end structures and the fixture.

8. The method of claim 1, wherein the biplate assemblies comprise respective first casing portions.

9. The method of claim 8, wherein the respective first casing portions comprise modular casing frames, the modular casing frames supporting a conductive substrate clad with active materials on opposing surfaces of the conductive substrate, the active materials having opposite polarities.

10. The method of claim 9, wherein the modular casing frames define vent structures that are staggered in location to avoid interference between adjacent ones of the modular casing frames when stacked.

11. The method of any one of claims 1 through 10, comprising manipulating the compressed stack of biplate assemblies using a robotic handler at least in part to establish a location where the irradiating the optically-absorbing is performed.

12. A method for fabricating a battery assembly, the method comprising:
assembling a stack of biplate assemblies including aligning the biplate assemblies using a fixture, the fixture having at least one feature sized and shaped to engage a corresponding feature in a first casing portion in the stack of biplate assemblies;
compressing the stack of biplate assemblies;
mating a panel comprising an optically-transmissive region to the first casing portion;
securing the compressed stack of biplate assemblies by end structures applied to the compressed stack of biplate assemblies, the end structures fastened to a fixture that aligns the compressed stack of biplate assemblies; and
irradiating an optically-absorbing region of the first casing portion through an optically-transmissive portion of the panel using a laser to thermally form a weld structure along at least one edge of the panel.

13. The method of claim 12, wherein the end structures, the fixture, and the compressed stack form a unitized assembly.

14. The method of claim 12, wherein the biplate assemblies comprise respective first casing portions.

15. The method of any one of claims 12 through 14, wherein the respective first casing portions comprise modular casing frames, the modular casing frames supporting a conductive substrate clad with active materials on opposing surfaces of the conductive substrate, the active materials having opposite polarities.

16. An assembly comprising:
two or more biplate assemblies;
a fixture comprising at least one feature sized and shaped to engage a corresponding feature in the two or more biplate assemblies to align the biplate assemblies in a stack for a welding operation; and
respective end structures fastened to the fixture to maintain compression of the two or more biplate assemblies.

17. The assembly of claim 16, wherein the fixture defines an aperture permitting mating of a second casing portion comprising an optically-transmissive region to respective first casing portions of the two or more biplate assemblies.

18. The assembly of claim 17, wherein the respective first casing portions comprise modular casing frames, the modular casing frames supporting a conductive substrate clad with active materials on opposing surfaces of the conductive substrate, the active materials having opposite polarities.

19. The assembly of claim 18, wherein the modular casing frames define vent structures that are staggered in location to avoid interference between adjacent ones of the modular casing frames when stacked.

20. The assembly of any one of claims 17 through 19, wherein the second casing portion comprises at least one of a fiber-loaded or a fiber-reinforced material.
